(19) United States
(12) Patent Application Publication
(10) Pub. No.: US 2001/0034645 A1
(43) Pub. Date: Oct. 25, 2001

(54) Advertising-sponsored free online university method

(76) Inventor: Samuel Sergio Tenembaum, Punta del Este (UY)

Correspondence Address: Samuel S. Tenembaum, 2nd Floor, 34 East 67 Street, New York, NY, 10021, US

(21) Appl. No.: 09/726,162

(22) Filed: Nov. 29, 2000

Related U.S. Application Data
(60) Provisional application No. 60/168,305, filed on Dec. 1, 1999.

(51) Int. Cl. G06F 17/60

(52) U.S. Cl. 705/14

(57) ABSTRACT

A new concept in academic studies is presented, that will be referred to here as UNIVERSIDADONLINE.COM

Universidadonline.com will offer totally free and totally online accredited academic degrees that will be funded mainly by advertising and by collateral sponsorship and E-commerce operations.

The virtual campus will be operated from an Internet Web Site (universidadonline.com) which will serve also as a education portal for the public in general and as an E-commerce arena for its students and other visitors.

The students will be able to conduct all their studies and exams from their own homes, without having to attend any real campus classes.

To our advertising sponsors we shall offer an unique opportunity to reach accurately targeted population segments and at large, access to a qualitative group of people, whose brand loyalty will be developed together with their strengthening of their consuming patterns, as a result of their gaining an academic degree.

### BACKGROUND OF THE INVENTION

The present invention relates generally to advertising-sponsored, free, online, accredited academic studies over the Internet, and, more particularly relates to business method to implement such virtual academic environment.

### BRIEF SUMMARY OF THE INVENTION

There is a vast offer of academic institutions worldwide. Broadly speaking, two major methods exist:

a. Presence-requiring Universities: Those that require the student's physical attendance.

b. Distance-Learning Universities: Those that enable the student to conduct part or most of all of his/her studies without attending campus classes. In this category, some institutions are incorporating online facilities to some extent.

Both aforementioned categories include some institutions that offer free or partially subsidized studies, but none of them, combine all of the following characteristics:

1. Totally free studies.

2. Totally online studies.

3. Accredited degrees.

Our invention comprises all these features.

### DETAILED DESCRIPTION OF THE INVENTION

In light of the above, there is therefore a need for a much more innovative academic environment which embraces the latest online technologies while offering wide populations free access to accredited academic studies. According to our invention, all the studies will be interactively conducted in a virtual campus environment, taking full advantages of the latest available Internet technologies. Our unique academic selling proposition will perfectly address the needs and postponed aspirations of those millions of people who due to either work, budgetary constraints, or whatever other reason, cannot even dream of attending time-consuming and expensive campus lessons. Our students will be able to conduct all their studies from home, following their own tailor-made time agenda, in a friendly virtual campus environment featuring the highest education standards. We shall tentatively refer to this invention here as UNIVERSIDADONLINE.COM. The virtual campus environment will be an Internet Web site, which tentatively shall be called www. universidadonline.com.

In accordance with the present invention, students will be able to pursue totally free undergraduate and graduate studies from their homes, using PC's with average system requirements and a regular Internet connection. The studies will be free thanks to the fact that most of the revenues will originate from on-line and offline advertising, sponsorship campaigns, data-base sales and e-commerce commissions proceeds. The advertising will be highly focused and segmented. Each sponsor will be able to penetrate pre-determined target populations. This accurate target will be achieved in the following manner: Upon signing-up, each student will fill-up a detailed socio-demographic questionnaire which will enable the implementation of a highly-focused advertising campaign. Each time a student logs-on to our website, he/she will be immediately identified and exposed to the “right” ads accordingly. Moreover, under this teaching and identification scheme, each student will have to download study material that will also carry pre-determined ads according to his/her own profile.

Our website will also be visited by general “non-student” visitors. This population will also be prompted through various incentives (prizes, discounts, lotteries, etc.) to sign-up through a questionnaire, so that each time a repeated visit occurs, the visitor can be identified by means of a “cookie” and exposed to the “right” advertisements accordingly.

At a first stage, the business model of this invention contemplates studies in two languages, namely English and Spanish. At a later stage, the more teaching languages will be added. Similarly, on the beginning, the business model of this invention contemplates the following undergraduate careers in both aforementioned languages:

Law

Political Sciences

Economics

Business Administration

Literature

History

Geography

Philosophy

Educational Sciences

Computer Studies

Mathematics

Psychology

Accounting

At a later stage, more careers will be introduced, including graduate ones.

Our virtual university will be aimed at a large population, which hitherto did not have the opportunity to pursue an academic degree. Our academic program is aimed at people of both sexes, interested in attaining a Bachelor Degree in one of the careers offered by us. Geographically speaking, we shall start by be positioned in the English-speaking and Spanish-speaking countries. Due to the prevailing role of the English language in the whole world, we expect that non-native English speakers will also be attracted by our academic offer.

In addition to the aforementioned definitions, our typical student will have the following profile:

Age: 18-70

Previous Education: High-School Diploma or equivalent.

Gender: both

Financial Situation: Existence of budgetary constraints so that the student will fully appreciate the opportunity of free studies.

Time constraints: Part-time or full-time employment, which makes difficult for the student to attend presence-requiring courses. Our student will value the importance of a flexible environment which enables him/her to draw-up his/her own pace and timetable.

Computer-literacy: Fair understanding of PC/Internet environment, or at least a positive learning attitude towards computers.

In order to attract the maximum number of general visitors to universidadonline.com, the website will be a sort of Education Portal, which will feature up to date education news items and in-depth articles, as well non-academic on-line courses in different areas.

In addition, universidadonline.com will also be an E-commerce arena. Relevant products and services, such as books, computers, stationary, cultural and social events, etc., will be offered to the students and to general visitors at specially attractive discount prices.

Another added value for our students will be the following: Our University will maintain a continuous contact with its graduate students population, offering update and complementary courses and assisting them in finding suitable jobs, whether in our institution or in affiliated firms.

The invention will also embrace a strong ecological message: We are living in a world where commuting is becoming increasingly cumbersome. Traffic jams create pollution, by itself a serious ecological threat on our planet, as well as car accidents and related personal security threats. All the traditional industries, including transportation, are lagging behind cybernetics. Inevitably, this trend will bring about a new generation of non-commuters, millions of virtual workers and students who will work and study from home, thanks to the emerging Internet technologies.

Our slogan to attract potential students will be:

“No more excuses for not having an academic degree! Universidadonline. com makes your dream come true!”

At a first stage, the invention will incorporate existing Internet interactive technologies (chatting, e-mail, video conferencing, real-audio, html pages, etc.) to convey the teaching material. Most of it will be downloadable from the Internet. Some of the homework and all exams will be uploadable back to our server for correction. Final exams will take place at the end of each course, ideally within 3 months (for students who are able to fully devote themselves to the studies). The procedure is quite simple. The exam is downloaded from the Internet and in order to be corrected by our staff, the student will have to nominate an accepted Proctor, whose responsibility is to be present during the test and to ensure that the exam is being properly administrated in terms of time allotment and in terms of normally accepted examination conditions and standards. A qualified Proctor should be 25 years old or over, have at least a Master or equivalent graduate degree and should be willing to sign a binding Proctor Agreement, whereby he or she commits to perform his/her Proctorate duties in the most impartial and fair way. Universdadonline.com will have the exclusive right to accept or dismiss any candidate or active Proctor.

Other technologies that are likely to be incorporated in our system are: MOVICOM-PCS, MP3, etc. With the advent of faster Internet connections (ADSL, cable modem) we shall incorporate video-conference capabilities. We shall also explore joint-venture possibilities with other suppliers of Virtual Campus Technologies and supporters of teaching and learning over the Internet, such as Real Education (rs.realeducation.com) and Blackboard, Inc. Our technological staff will keep abreast of these advances so that our students will always enjoy the most advanced technologies.

For those students who will be interested in securing extra-interactivity-support from our staff, we shall be offering a PREMIUM PACKAGE OPTION which contemplates human tutors and teaching assistants. This Premium Package will have a cost to the students but, it should be emphasized that this option will not be required for a student to complete a degree. The studies will be absolutely and completely free. There will be no registration fees, nor any tuition fees whatsoever

As previously mentioned, most of the revenues of this business model will be derivated from advertising and collateral services, as per the following detail:

Online ads

Offline ads

Sponsorships and Endowments

Web-Commerce commissions

Data Base sales

Our advertising method will enable our sponsors to channel their ads to the desired targets, with maximum focus, without wasting budget on irrelevant target audiences. All our students, upon registration, will fill-in a detailed questionnaire which will give us a clear profile of each individual. At the same time, each student will be assigned a username and password, so that each time he/she logs in our system or downloads our material we shall be in a position to insert the proper advertising, based on the student's detailed profile.

As far as our general visitors will be concerned, we shall know, at least, their geographic whereabouts. Moreover, we shall entice them by means of a variety of incentives to sign-up with us, in which case, they will be asked to fill-in a profile questionnaire and will be assigned a distinctive username and password which will trigger the “focused advertising software”.

Online ads refer to all kind of advertisement methods (banners, microsites, shoshkeles, etc.) that will appear in our website. These online ads will be aimed at two well differentiated population segments:

Our students+our non-students visitors.

Offline ads refer to all kind of advertisement methods (as above) that will appear in our donwloadable material, exclusive for our students. As opposed to the online ads, the offline ads will naturally not allow click-through features to our advertisers' own sites and will not be seen by our online non-students visitors. On the other hand, our captive student population will be more extensively exposed to them due to the longer average time required to browse the downloaded contents, in comparison with the online material.

Both online and offline ads will be charged, at a first stage, according to the popular CPM method (Cost per Thousand Impressions). At a later stage, other pricing methods may be incorporated.

Sponsorships and Endowments refer to a more elaborated kind of advertising in terms of technologies employed and brand-building capabilities. The sponsors will be large business entities that wish to launch a carefully planned imaging campaign as well as private individuals who are interested in funding a specific course or career in memory of a beloved late relative or within a more general charitable context. Typically, sponsorship and endowment advertisements will be presented in multimedia and will accompany the students all year around.

Web-Commerce commissions refer to the contingent fees we shall be receiving from our business partners who will sell their goods and services through our Internet site.

Data Base Sales refer to the proceeds we shall receive from the sale of our data base to business entities interested in direct marketing. Our data base will be formatted and segmented in a sophisticated configuration, with useful statistical socioeconomic, demographic and spending parameters. The purchasers of the data base will be committed to our strict ethic rules regarding the permitted ways to approach our students. The sale of our data base will be in the form of an annual subscription with periodical updates.

As far as our advertisers will be concerned, our invention offers them a unique selling proposition in terms of the qualitative value of our target population. As we are approaching the end of the millennium, the name of the game is Branding Awareness. More and more business entities nowadays are realizing that advertising's main objective is to build-up a long-run branding awareness and loyalty, as opposed to short-term considerations such as next quarter's sales increase. The Internet in general is widely being perceived as “the” vehicle for strengthening branding awareness and loyalty. We strongly believe that our website in particular will be an outstanding brand-awareness-builder tool. On the one hand, as mentioned above, we can offer an extremely well targeted consumer population, with precisely defined socio-economic and demographic patterns. On the other hand, our online students will be a group of highly motivated individuals striving to attain a degree as a means to move up in the labor market ladder. Advertisers crave for the opportunity of accompanying such audiences way up to senior positions in the economy. This captive audience is an ideal one in terms of developing brand loyalty, not only because its present virtues but mostly because its future economic profile and consumption patterns.

1. I claim a method for offering advertising-sponsored free online academic studies, substantially as described.
